(19) United States
(12) Patent Application Publication
(10) Pub. No.: US 2025/0066619 A1
(43) Pub. Date: Feb. 27, 2025

(54) CHROMIUM-FREE ANTICORROSIVE COATING COMPOSITION AND ARTICLE MADE THEREFORM

(71) Applicant: GUANGDONG HUARUN PAINTS CO., LTD., Foshan, Guangdong (CN)

(72) Inventors: Kai HE, Foshan, Guangdong (CN); Rong XIONG, Foshan, Guangdong (CN); Xi ZHAO, Foshan, Guangdong (CN); Yu ZHANG, Foshan, Guangdong (CN); Wenbin ZHENG, Shanghai (CN)

(21) Appl. No.: 18/724,065

(22) PCT Filed: Dec. 23, 2022
(86) PCT No.: PCT/CN2022/141593

§ 371 Date: Jun. 26, 2024

(30) Foreign Application Priority Data
Dec. 28, 2021 (CN) 202111631394.7

(51) Int. Cl. C09D 5/10; C09D 5/12

(52) U.S. Cl. CPC C09D 5/10; C09D 5/12

(57) ABSTRACT

The present application is directed to chromium-free anticorrosive coating composition and article made therefrom. The chromium-free anticorrosive coating composition comprises Component A, comprising a film-forming composition, a corrosion inhibiting composition, optional carriers and additional additives, wherein the corrosion inhibiting composition comprises at least one lithium-containing metal compound having a spatially stable crystalline structure, and at least one aluminum-containing phosphate; and optionally Component B, comprising a curing agent. The chromium-free anticorrosive coating composition according to the present application may be used as a primer or a direct-to-metal coating, especially suitable for a primer in a wet-on-wet system. The present application further discloses an article, comprising a metal substrate; and a coating formed of the above chromium-free anticorrosive coating composition which is directly applied to the metal substrate.

### TECHNICAL FIELD

The present application relates to an anticorrosive coating composition, and more specifically to a chromium-free anticorrosive coating composition with an excellent anticorrosive performance and an article made therefrom.

### BACKGROUND

Metal corrosion is known as a process in which a metal material is in contact with the surrounding environment and experiences a certain reaction where the material is gradually deteriorated or destroyed. Metal corrosion is a common natural phenomenon, occurring as rust on the surface of steel, white powder on the surface of aluminum products, and so on. In order to prevent metal substrates from being corroded, the substrates can be treated with anticorrosive treatments. Such anticorrosive treatments provide important safeguards that prolong the service life of metal substrates and ensure safety of applications.

It is recognized that hexavalent chromium compounds can provide coatings with very good anticorrosive ability. They are not only effective over a wide range of pH, but also have self-repairing functions, and therefore are considered almost irreplaceable as anticorrosive pigments/fillers. However, hexavalent chromium is toxic. Since the 1920s, there have been records showing that hexavalent chromium is carcinogenic in nature. Previous studies have shown that incidence of nasal cancer and lung cancer in industrial workers who are directly exposed to Cr⁶⁺ compounds has increased significantly. In view of this concern for the environment and for worker safety, the call for gradually reducing or even eliminating the application of hexavalent chromium compounds in anticorrosive coatings has increased.

Therefore, there is need in the coating industry for chromium-free anticorrosive coating compositions.

### SUMMARY

The present application provides a chromium-free anticorrosive coating composition, comprising: Component A, comprising a film-forming composition, a corrosion inhibiting composition, optional carriers and additional additives, wherein the corrosion inhibiting composition comprises at least one lithium-containing metal compound having a spatially stable crystalline structure, and at least one aluminum-containing phosphate; and optionally Component B, comprising a curing agent.

In some embodiments of the present application, the at least one lithium-containing metal compound has a layered structure, a spinel structure, an olivine structure or a tunnel structure. Preferably, the at least one lithium-containing metal compound comprises a lithium-containing composite metal compound further comprising at least one transition metal element, preferably the at least one transition metal element is one or more selected from nickel, cobalt, manganese, iron and titanium. As an exemplary illustration, the lithium-containing metal compound is one or more selected from the group consisting of lithium manganese oxide, lithium nickel cobalt manganese oxide, lithium cobalt oxide, lithium phosphate and lithium iron phosphate, preferably lithium iron phosphate.

In some embodiments of the present application, the at least one aluminum-containing phosphate comprises one or more of aluminum-containing orthophosphate, aluminum-containing polyphosphate, aluminum-containing metaphosphate, aluminum-containing phosphite, and aluminum-containing hypophosphite, preferably aluminum-containing polyphosphate, and more preferably aluminum tripolyphosphate.

In some embodiments of the present application, the corrosion inhibiting composition further comprises at least one cation exchange silica gel. Preferably, the at least one cation exchange silica gel is porous. More preferably, the at least one cation exchange silica gel comprises one or more of magnesium ion exchange silica gel, barium ion exchange silica gel, aluminum ion exchange silica gel and calcium ion exchange silica gel, preferably calcium ion exchange silica gel.

The present application also provides an article comprising a metal substrate; and a coating formed of the chromium-free anticorrosive coating composition according to the present application which is directly applied to the metal substrate. Preferably, the metal substrate is one or more selected from steel, iron, aluminum, zinc, copper and alloys thereof.

It was surprisingly discovered by the inventors of the present application that in the formulation of a chromium-free anticorrosive coating composition, the use of a corrosion inhibiting composition comprising at least one lithium-containing metal compound and at least one aluminum-containing phosphate as a rust inhibitor allows the paint film formed therefrom to exhibit not only excellent corrosion resistance in which said corrosion resistance is demonstrated by the fact that the formed film has a stripping width of no more than 3 mm on one side after a salt spray test according to ASTM B 117 for at least 500 hours or longer, or a stripping width of no more than 2 mm on one side after a salt spray test according to GB/T1771 for at least 1000 hours or longer but also to exhibit excellent water resistance in which said water resistance is demonstrated by the fact that the formed film does not blister after being stored in water at 40° C. for 12 days or longer, which was not foreseen prior to the present application.

Without wishing to be bound by any theory, it is speculated that the chromium-free anticorrosive coating composition of the present application can achieve the aforementioned anticorrosive effect for the following reasons.

In the formulation of the chromium-free anticorrosive coating composition of the present application, said corrosion inhibiting composition comprises at least one lithium-containing metal compound, and this lithium-containing metal compound has a spatially stable crystal structure. In a corrosive environment, the lithium-containing metal compound contained in the coating formed by the above-mentioned anticorrosive coating composition can release and/or leach lithium ions therein, and the dissociated lithium ions act as a cathode inhibitor and react with oxygen, water, and the like in the environment to form a passivation layer so that it may protect a metal substrate from external corrosion. On the other hand, the lattice structure of the lithium-containing metal compound is basically stable and will not collapse, so that the paint film will not lose its adhesion while keeping a certain strength. Therefore, the corrosion inhibiting composition containing the lithium-containing metal compound can provide an anticorrosive coating composition with an effective anticorrosive performance.

In the formulation of the chromium-free anticorrosive coating composition of the present application, said corrosion inhibiting composition further comprises at least one aluminum-containing phosphate. In a corrosive environment, the aluminum-containing phosphate can release and/or leach aluminum ions therein, and the dissociated aluminum ions combine with the lithium ions dissociated from the above lithium-containing metal compound, oxygen, water and the like in the environment to produce a similar anticorrosive effect to that of water-soluble lithium salts on metallic aluminum substrates, i.e., to form insoluble LiₓAl_{y}(OH)_{z}. In other words, in the corrosion inhibiting composition of the present application, the lithium-containing metal compound and the aluminum-containing phosphate can produce a synergistic effect. Further, the aluminum-containing phosphate produces free phosphate upon dissociation of aluminum, and this phosphate can bind to metal ions from the metal substrate to form a passivation layer. Thus, the incorporation of the aluminum-containing phosphate in the corrosion inhibiting composition is more beneficial to improving the anticorrosive performance of the resulting coating.

Preferably, in the formulation of the chromium-free anticorrosive coating composition of the present application, the corrosion inhibiting composition further comprises at least one cation exchange silica gel. In a corrosive environment, aggressive ions such as (H+), which penetrate into the coating film, are exchanged with cations, such as calcium ions (Ca²⁺), on the surface of the particles of silica gel, resulting in the release of corresponding cations that subsequently migrate to the interface of the metal substrate and further form a protective film at the interface of the metal substrate. It can thus be seen that the cation exchange silica gel not only adsorbs aggressive ions from the environment, but also forms a protective film at the interface of the metal substrate. Therefore, the corrosion inhibiting composition preferably further comprises at least one cation exchange silica gel as an enhancer to further enhance the anticorrosive effect of the lithium-containing metal compound with the aluminum-containing phosphate.

In summary, the corrosion inhibiting composition comprising at least one lithium-containing metal compound, at least one aluminum-containing phosphate and optionally at least one cation-exchange silica gel is used as a rust inhibitor, so that each corrosion inhibiting component promotes each other and acts synergistically, thereby obtaining the resulting paint film formed therefrom showing not only excellent corrosion resistance but also excellent water resistance.

It was further surprisingly discovered by the inventors of the present application that the chromium-free anticorrosive coating composition according to the present application can be used not only as a primer for wet-to-dry systems but also as a primer for wet-to-wet systems, and that the chromium-free anticorrosive coating composition according to the present application not only does not cause construction problems such as sagging and streaking when used as a primer for wet-to-wet systems, but also achieves excellent corrosion resistance.

The details of one or more embodiments of the present disclosure are set forth in the description below. Other features, objects, and advantages of the present disclosure will be apparent from the description, and from the claims.

### DESCRIPTION OF THE DRAWINGS

FIG. 1 shows photographs of four test samples of a composite coating forming by coating a primer layer formed from the epoxy-based chromium-free anticorrosive coating composition according to Example 5 of the present application with a water-based polyurethane topcoat after undergoing the ASTM B117 salt spray resistance test for 504 hours (upper coatings) and 785 hours (lower coatings), respectively.

FIG. 2 shows photographs of two test samples of a composite coating forming by coating a primer layer formed from the epoxy-based chromium-free anticorrosive coating composition according to Example 5 of the present application with a water-based polyurethane topcoat after subjecting to immerse in an aqueous environment at 40° C. for 12 hours where the coating above the black line is not immersed into water and the coating below the black line is immersed into water.

FIG. 3 shows photographs of two test samples of a composite coating forming by coating a primer layer formed from the epoxy-based chromium-free anticorrosive coating composition according to Example 5 of the present application with a water-based polyurethane topcoat after subjecting to immerse in an aqueous environment at room temperature for 500 hours where the coating above the black line is not immersed into water and the coating below the black line is immersed into water.

FIG. 4 shows photographs of two test samples of a composite coating forming by coating a primer layer formed from the epoxy-based chromium-free anticorrosive coating composition according to Example 6 of the present application with a water-based polyurethane topcoat after undergoing the ASTM B 117 salt spray resistance test for 525 hours (left coating) and 825 hours (right coatings), respectively.

FIG. 5 shows photographs of a composite coating forming by coating a primer layer formed from the epoxy-based chromium-free anticorrosive coating composition according to Example 6 of the present application with a water-based polyurethane topcoat after subjecting to immerse in an aqueous environment at 40° C. for 12 hours.

FIG. 6 shows photographs of a composite coating forming by coating a primer layer formed from the epoxy-based chromium-free anticorrosive coating composition according to Example 6 of the present application with a water-based polyurethane topcoat after subjecting to immerse in an aqueous environment at room temperature for 500 hours.

### DEFINITION

As used herein, “a”, “an”, “the”, “at least one”, and “one or more” are used interchangeably. Thus, for example, a composition that comprises “an” additive can be interpreted to mean that the composition includes “one or more” additives.

Throughout the present disclosure, where compositions are described as having, including, or comprising specific components or fractions, or where processes are described as having, including, or comprising specific process steps, it is contemplated that the compositions or processes as disclosed herein may further comprise other components or fractions or steps, whether or not, specifically mentioned in this invention, as along as such components or steps do not affect the basic and novel characteristics of the present disclosure, but it is also contemplated that the compositions or processes may consist essentially of, or consist of, the recited components or steps.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

The term “anticorrosive coating composition” refers to a coating composition that, when applied to a metal substrate in one or more layers, can form a coating layer that can be exposed to corrosive conditions over a relatively long period, for example, salt spray exposure for three weeks or more without obvious visible deterioration or corrosion.

When used for “chromium-free anticorrosive coating composition”, the term “chromium-free” means that various components of the coating composition and the formulated coating composition do not contain any additional hexavalent chromium ions, preferably do not contain any chromium compounds. When the phrases “does not contain”, “does not contain any”, and so on are used herein, such phrases are not intended to exclude the presence of trace related structures or compounds that may exist as environmental pollutants or due to environmental pollution.

As used herein, the term “lithium-containing metal compound” refers to a compound formed from a metallic lithium, which may be an oxide, a fluoride or an oxo acid salt. In some embodiments of the present application, the “lithium-containing metal compound” may further contain at least one transition metal element in addition to lithium and thus the lithium-containing metal compound may also be known as a “lithium-containing composite metal compound”. In some embodiments of the present application, the transition metal element is one or more selected from nickel, cobalt, manganese, iron and titanium.

When used for “lithium-containing metal compound”, the phrase “having releasable and/or leachable lithium ions” means that under corrosive conditions, such as 50% by weight aqueous sodium chloride spray at 35° C. or higher, lithium in the lithium-containing metal compound can be dissociated into lithium ions.

When used for “lithium-containing metal compounds”, the phrase “having a spatially stable crystal structure” means that the compound has structural stability, namely a crystal structure that is conducive to intercalation into and deintercalation out of lithium ions (abbreviated as “intercalation-deintercalation”), and where the crystal structure remains basically stable during the intercalation-deintercalation of lithium ions without major lattice changes. When the coating formed by the coating composition containing the lithium-containing metal compound is under certain conditions, especially under corrosive conditions for example, 5% by weight sodium chloride aqueous spray at 35° C. for 600 hours or longer, the lithium-containing metal compound in the coating maintains a spatially stable three-dimensional structure after the dissociation of lithium ions, and the coating does not appear to collapse, develop voids, and the like. The phenomenon of “collapse, voids and the like” on the surface of coating described here may be measured by scanning electron microscope (SEM). The “spatially stable crystal structure”, as an example, may be a layered structure, a spinel structure, an olivine structure, or a tunnel structure.

When used for in connection with a “corrosion inhibiting composition”, the term “aluminum-containing phosphate” means any phosphate containing an aluminum cation, including, but not limited to, an aluminum-containing orthophosphate, an aluminum-containing polyphosphate, an aluminum-containing metaphosphate, an aluminum-containing phosphite, and aluminum-containing hypophosphate.

When used in connection with “corrosion inhibiting compositions”, the term “cation-exchange silica gel” refers to amorphous silica gel on which a cation is adsorbed or attached, said cation being exchangeable with a specific cation e.g., a hydrogen ion.

When used for “chromium-free anticorrosive coating composition”, the term “film-forming composition” refers to a component that may form a non-sticky (i.e. dry or hardened) continuous film on the substrate after it is mixed with other components in the coating composition (such as carriers, additives, fillers, and the like), and the resulting mixture is applied to the substrate and dried, cross-linked or otherwise hardened together with a suitable curing agent as required. The “film-forming composition” mainly includes resin components, but may also include film-forming materials such as inorganic silicates.

When used herein, the term “primer” refers to a coating composition that can be applied to a metal substrate and dried, crosslinked, or otherwise hardened to form a non-sticky continuous film having sufficient adhesion to the surface of substrate.

As used herein, the term “direct-to-metal coating (DTM)” refers to a coating composition that can be applied to a metal substrate and dried, crosslinked, or otherwise hardened to form a non-sticky continuous film that has sufficient adhesion on the surface of substrate, and can withstand long-term outdoor exposure without showing visible and unsatisfactory deterioration. The direct-to-metal coating (DTM) not only functions as a primer, having strong adhesion and corrosion resistance, but also as a topcoat, showing a good appearance and decorative effect. Compared to the process of applying primer and topcoat separately, the direct-to-metal coating (DTM) can reduce construction costs and time.

When used herein, the term “wet-on-wet system” refers to a coating system formed by a “wet-on-wet process” where the wet-on-wet process refers to a coating process in which a second coat of paint is applied before the first coat of paint is dry deeply. In some embodiments of the present application, the anticorrosive coating composition according to the present application can be used as a primer for wet-on-wet systems, which not only does not cause construction problems such as sagging and wrinkling, but also achieves excellent anticorrosive performances.

When used herein, the term “wet-on-dry system” refers to a coating system formed by a “wet-on-dry process” where the wet-to-dry process refers to a coating process in which a second coat of paint is applied after the first coat of paint has dried deeply. In the coating industry, the wet-on-dry process is the most commonly used process for applying multiple layers of coatings and is applicable to most coatings.

The term “comprises”, “comprising”, “contains” and variations thereof do not have a limiting meaning where these terms appear in the description and claims.

The terms “preferred” and “preferably” refer to embodiments of the present disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the present disclosure.

### DETAILED DESCRIPTION

The present application in one aspect provides a chromium-free anticorrosive coating composition, comprising: Component A, comprising a film-forming composition, a corrosion inhibiting composition, optional carriers and additional additives, wherein the corrosion inhibiting composition comprises at least one lithium-containing metal compound having a spatially stable crystalline structure, and at least one aluminum-containing phosphate; and optionally Component B, comprising a curing agent.

As described in the background, the call for gradually reducing or even eliminating the application of hexavalent chromium compounds in anticorrosive coatings has increased. In view of this, in recent years, a lot of research has been conducted to look for alternative anticorrosive pigments/fillers to replace hexavalent chromium compounds. Although many alternative reagents have been proposed, none of them have been shown to be as acceptable in anticorrosive coating applications as hexavalent chromium compounds. The primary goal of selecting anticorrosive pigments/fillers is to formulate coatings that meet the corrosion resistance standards of ASTMB117 salt spray test, which is a recognized aviation and aerospace industry method, and may meet the water resistance test. In practice, the conventional anticorrosive pigments/fillers such as aluminum tripolyphosphate cannot be formulated to meet corrosion resistance standards of coatings and to meet the corrosion resistance of coatings.

As described above, it was surprisingly discovered by the inventors of the present application that in the formulation of a chromium-free anticorrosive coating composition, the corrosion inhibiting composition comprises a combination of at least one lithium-containing metal compound and at least one aluminum-containing phosphate, which allows the paint film formed therefrom to exhibit not only excellent corrosion resistance in which said corrosion resistance is demonstrated by the fact that the formed film has a stripping width of no more than 3 mm on one side after a salt spray test according to ASTM B 117 for at least 500 hours or longer, or a stripping width of no more than 2 mm on one side after a salt spray test according to GB/T1771 for at least 1000 hours or longer but also to exhibit excellent water resistance in which said water resistance is demonstrated by the fact that the formed film does not blister after being stored in water at 40° C. for 12 days or longer.

In embodiments according to the present application, the chromium-free anticorrosive coating composition comprises a corrosion inhibiting composition and the corrosion inhibiting composition comprises at least one lithium-containing metal compound. As mentioned above, the lithium-containing metal compound is a metal compound formed from a lithium element, and may be an oxide, a fluoride or an oxo acid salt. Preferably, the lithium-containing metal compound may further comprise at least one transition metal element, such as cobalt, nickel, manganese, iron, titanium, or a combination thereof and thus may also be known as a “lithium-containing composite metal compound”. Moreover, the lithium-containing metal compound has a spatially stable crystal structure, which structure remains basically stable in case of intercalation-deintercalation.

It is well known that lithium-containing metal compounds, especially lithium-containing composite metal compounds are not a component for the formulation of a coating composition in the coating industry. However, it was surprisingly found by the inventors of the present application that lithium-containing metal compounds having a spatially stable crystal structure are particularly suitable as an anticorrosive or anti-rust pigment/filler, and the paint film formed therefrom will have a lower stripping width on one side after a salt spray test according to ASTM B117 and/or GB/T1771, has excellent wet adhesion, and is low in cost.

Typically, the above-mentioned lithium-containing metal compounds can be used as positive electrode materials in the field of lithium-ion batteries. Prior to the present application, there is no prior disclosure and teaching that the lithium-containing metal compound can be used as an anticorrosive pigment/filler of an anticorrosive coating composition. The above findings of the inventors of the present application were unforeseeable prior to the present application. Without being bound by any theory, the applicant believes that in a corrosive environment, for example, 5% by weight sodium chloride aqueous spray at 35° C. for 500 hours or more for example 1000 hours, the lithium-containing metal compound contained in the coating formed from the above-mentioned anticorrosive coating composition can release and/or leach lithium ions therein, and the dissociated lithium ions act as a cathode inhibitor and react with oxygen, water, and the like in the environment to form a passivation layer that may protect a metal substrate from external corrosion. On the other hand, the lattice structure of the lithium-containing metal compound is basically stable in the process of dissociation of lithium ions and will not collapse, so that the paint film will not lose its adhesion while keeping a certain strength, thereby achieving an anticorrosive effect. The above lithium-containing metal compound is different from water-soluble lithium salts and other lithium salts, such as lithium silicate in terms of structure and anticorrosive mechanism.

In some embodiments of the present application, the lithium-containing metal compound may have a layered structure, a spinel structure, an olivine structure, or a tunnel structure.

In some embodiments of the present application, the lithium-containing metal compound is one or more selected from the group consisting of lithium manganese oxide, lithium nickel cobalt manganese oxide, lithium cobalt oxide, lithium phosphate and lithium iron phosphate. In a preferred embodiment of the present application, the lithium-containing metal compound is a lithium-containing composite metal compound, such as lithium iron phosphate.

The above lithium-containing metal compound may be any known commercially available product, for example, any known commercially available lithium-containing composite metal compound. As an exemplary illustration of commercially available lithium-containing composite metal compounds, lithium manganese oxide commercially available from Dameng of CITIC, lithium nickel manganese cobalt oxide commercially available from Dameng of CITIC, lithium nickel manganese cobalt oxide commercially available from Rongbai, lithium iron phosphate commercially available from Shanghai Oujin, Shanghai Betray and Hunan Yuneng or a combination thereof may be used.

Preferably, said lithium-containing metal compound is present in an amount of 0.5% by weight or more, preferably 1.0% by weight or more, but not more than 6.0% by weight, relative to the total weight of component A. In a specific embodiment of the present application, the lithium-containing metal compound is present in an amount of from about 0.5 to about 5.0% by weight, or in an amount of from about 1.0 to about 4.5% by weight, or in an amount of from about 2.0 to about 4.5% by weight, or in an amount of from about 3.0 to about 4.5% by weight, or in an amount of from about 1.0 to about 3.5% by weight, relative to the total weight of component A.

In embodiments of the present application, the corrosion inhibiting composition contained in the chromium-free anticorrosive coating composition further comprises at least one aluminum-containing phosphate. As described above, an aluminum-containing phosphate is a salt composed of aluminum cation and any phosphate radical, which can dissociate aluminum ions under a specific condition, such as a corrosion condition. It was surprisingly found by the inventors of the present application that in the chromium-free anticorrosive coating composition of the present application, such an aluminum-containing phosphate can produce a synergistic effect with the above lithium-containing metal compound, thereby further improving the anticorrosive effect of the lithium-containing metal compound. Specifically, in a corrosive environment, the above aluminum-containing phosphate can release and/or leach aluminum ions therein, and the dissociated aluminum ions may combine with the lithium ions dissociated from the above lithium-containing metal compound, oxygen, water and the like in the environment to produce a similar anticorrosive effect to that of water-soluble lithium salts on metallic aluminum substrates, i.e., to form insoluble LiₓAl_{y}(OH)_{z} as the main component of an anticorrosive coating. Further, the aluminum-containing phosphate produces free phosphate radical upon dissociation of aluminum, and this phosphate radical can bind to metal ions such as ferrous ions and iron ions from the metal substrate to form a passivation layer. Thus, the incorporation of the aluminum-containing phosphate in the corrosion inhibiting composition is more beneficial to improving the anticorrosive effect of the lithium-containing composite metal compound.

In some embodiments of the present application, said aluminum-containing phosphate includes, but not limited to, an aluminum-containing orthophosphate, an aluminum-containing polyphosphate, an aluminum-containing metaphosphate, an aluminum-containing phosphite, and an aluminum-containing hypophosphate. In a preferred embodiment of the present application, said aluminum-containing phosphate comprises an aluminum-containing polyphosphate. In a more preferred embodiment of the present application, said aluminum-containing phosphate comprises aluminum tripolyphosphate.

The above-mentioned aluminum-containing phosphate may be any known commercially available product. As an exemplary illustration of a commercially available product of an aluminum-containing phosphate, commercially available aluminum tripolyphosphate from SNCZ, HALOX, New Crystal Technology or a combination thereof may be used.

Preferably, said aluminum-containing phosphate is present in an amount of 1.0% by weight or more, preferably 2.0% by weight or more, but not more than 7.0% by weight, relative to the total weight of component A. In a specific embodiment of the present application, said component A, relative to the total weight of component A, comprises from about 1.0 to 7.0% by weight of the aluminum-containing phosphate, or from about 1.0 to 5.5% by weight of the aluminum-containing phosphate, or from about 2.0 to 5.5% by weight of aluminum-containing phosphate, or from about 3.0 to 5.5% by weight of the aluminum-containing phosphate, or from about 2.0 to 3.0% by weight of the aluminum-containing phosphate.

In some embodiments according to the present application, the corrosion inhibiting composition contained in the chromium-free anticorrosive coating composition may further comprise at least one cation-exchange silica gel.

As described above, said cation-exchange silica is an amorphous silica having cations adsorbed or attached thereto. In a corrosive environment, aggressive ions such as (H+), which penetrate into the coating film, are exchanged with cations, such as calcium ions (Ca²⁺), on the surface of the particles of silica gel, resulting in the release of corresponding cations that subsequently migrate to the interface of the metal substrate and further form a protective film at the interface of the metal substrate. It can thus be seen that the cation exchange silica gel not only may adsorb aggressive ions from the environment, but also may form a protective film at the interface of the metal substrate. Without being bound by any theory, the inventors believe that cation-exchange silica gel can form a protective film at the interface between the metal substrate and the coating by the following. In a corrosive condition, a metal substrate such as iron is oxidized to ferrous ions (Fe²⁺) in an anodic zone and then further oxidized to ferric ions (Fe³⁺); at the same time, oxygen (O₂) and water (H₂O) in the air can penetrate through the resulting coating to the interface between the coating and the metal substrate and be reduced to hydroxide ions, which is known as a cathodic reaction. Depending on the concentration of OH— in the coating, amorphous silica (SiO₂) in the cation-exchange silica gel can be more or less partially dissolved into silicate ions (SiO₃²⁻). The generated SiO₃²⁻ ions react with iron ions at the coating/metal interface, thus forming a protective layer of iron silicate (Fe₂(SiO₃)₃); at the same time, cations released from the cation-exchange silica gel e.g. Ca²⁺ cations react with the dissolved SiO₃²⁻ ions so that a protective film of calcium silicate (CaSiO₃) is formed in the alkaline region of the metal interface. CaSiO₃ and Fe₂(SiO₃)₃ are deposited together to form a composite protective film layer at the metal interface. In addition, the cations e.g. Ca²⁺ cations released from the cation-exchange silica gel can interact with the dissociated phosphate e.g. polyphosphate and OH— in the coating system to form calcium phosphate (Ca₃(PO₄)₂) and water molecules, thus forming a calcium phosphate barrier layer that prevents oxygen from approaching the surface of the metal substrate.

It can be seen that it is preferable to include cation exchange silica gel in the corrosion inhibiting composition, which acts as an enhancer to further enhance the anticorrosive effect of the lithium-containing metal compound with the aluminum-containing phosphate.

In some embodiments of the present application, said cation-exchange silica gel is porous. It is advantageous to have a cation exchange silica gel having a porous structure because the cation exchange silica gel having such a structure can carry a larger amount of cations, thus facilitating the formation of the above mentioned protective film.

In some embodiments of the present application, the cation-exchange silica gel is basic or neutral, having a pH of at least 7.0. Preferably, the pH of the cation-exchange silica gel is in the range of 7.0 to 11.5, more preferably, in the range of 7.5 to 11.2. In one embodiment of the present application, the pH of the cation-exchange silica gel is in the range of 7.5 to 9.0. In another embodiment of the present application, the pH of the cation-exchange silica gel is in the range of 9.0 to 11.2.

In some embodiments of the present application, said at least one cation-exchange silica gel comprises magnesium ion-exchange silica gel, barium ion-exchange silica gel, aluminum ion-exchange silica gel, and calcium ion-exchange silica gel. In a preferred embodiment of the present application, said at least one cation-exchange silica gel comprises a calcium-ion-exchange silica gel.

Preferably, said cation-exchange silica gel is present in an amount of 1.0% by weight or more, but not more than 2.5% by weight, relative to the total weight of component A. In a specific embodiment of the present application, said component A comprises from about 1.0 to 2.5% by weight of the cation-exchange silica gel, or from about 1.5 to 2.5% by weight of the cation-exchange silica gel, or from about 1.5 to 2.0% by weight of the cation-exchange silica gel, or from about 1.0 to 2.0% by weight of the cation-exchange silica gel, or from about 1.5% by weight to 1.8% by weight of the cation-exchange silica gel, relative to the total weight of component A.

In some embodiments according to the present application, the corrosion inhibiting composition contained in the chromium-free anticorrosive coating composition optionally comprises at least one organic corrosion inhibitor. Examples of the organic corrosion inhibitor include, but are not limited to, sulfur-containing and/or nitrogen-containing heterocyclic compounds, examples of which include thiophene, hydrazine and derivatives thereof, and pyrrole and derivatives thereof. In a specific embodiment of the present application, the organic corrosion inhibitor is present in an amount of about 0 to about 1.5% by weight, or about 0.1 to about 1.0% by weight, or about 0.1 to about 0.75% by weight, or about 0.25 to about 0.75% by weight, or about 0.25% by weight to about 0.50% by weight, relative to the total weight of component A.

In some embodiments according to the present application, preferably, said component A, relative to the total weight of said component A, comprises from about 3% by weight to about 15% by weight of the corrosion inhibiting composition. In some embodiments of the present application, said component A, relative to the total weight of said component A, comprises at least about 6% by weight, or at least about 6.5% by weight, or at least about 7% by weight, or at least about 8% by weight of the corrosion inhibiting composition. In the above embodiments of the present application, said component A, relative to the total weight of said component A, comprises less than about 15% by weight, or less than about 13% by weight, or less than about 12% by weight of the corrosion inhibiting composition.

In some embodiments according to the present application, the chromium-free anticorrosive coating composition is a two-component coating composition comprising a component A and a component B, said component A comprising a film-forming composition, a corrosion-inhibiting composition, an optional carrier and additional additives, and said component B comprising a curing agent. Prior to construction, said component A is mixed with said component B and then applied.

In some other embodiments according to the present application, said chromium-free anticorrosive coating composition is a one-component coating composition comprising component A, said component A comprising a film-forming composition, a corrosion-inhibiting composition, an optional carrier and additional additives. In these embodiments, said film-forming composition may be cured to form a film by, for example, self-crosslinking.

In embodiments according to the present application, the film-forming composition refers to a composition that constitutes the main body of a coating formed from the chromium-free anticorrosive coating composition, which comprises a resin component and may also comprise, independently or additionally, an inorganic silicates film-forming material.

In some embodiments according to the present application, the above-mentioned inorganic silicates film-forming material is used for providing a film-forming composition for the chromium-free anticorrosive coating composition. In one aspect, the inorganic silicates film-forming material functions as a binder which provides adhesion of coating to a substrate, and holds together other components, such as fillers, of the coating composition to impart basic cohesive strength to the paint film forming from the coating composition of the present disclosure. The chromium-free anticorrosive coating composition using this inorganic silicates as a film-forming substance has an additional beneficial effect of abrasion resistance, which has attracted attention in recent years.

In some embodiments according to the present application, the above-mentioned resin component is used for providing a film-forming composition for the chromium-free anticorrosive coating composition. The resin component may be for example at least one selected from epoxy resins, chlorinated resins, polyaspartates, alkyd resins, phenolic resins, polyurethanes, polysiloxanes, polyesters, and acrylics resin. In a currently preferred embodiment, the resin component may be at least one of selected from epoxy resin, polyester and acrylics resin. In a currently more preferred embodiment, the resin component may be selected from epoxy resin.

In a preferred embodiment according to the present application, the resin component is epoxy resin. The term “epoxy resin” as used herein refers to a polymer or oligomer containing two or more epoxy groups in one molecule. Preferably, the epoxy resin contains at most four epoxy groups in one molecule. More preferably, the epoxy resin contains two or three epoxy groups in one molecule. According to some embodiments of the present application, the epoxy resin may have an epoxy equivalent varying over a wide range, wherein the epoxy equivalent is the mass of an epoxy resin containing 1 mole of epoxy group. For example, the epoxy resin may comprise a low epoxy equivalent epoxy resin, a high epoxy equivalent epoxy resin or its combination thereof. As used herein, the epoxy resin having an epoxy equivalent between 400 and 700 g/eq, preferably between 450 and 550 g/eq is known as a low epoxy equivalent epoxy resin. The epoxy resin having a higher epoxy equivalent, such as having an epoxy equivalent greater than 800 g/eq, is known as a high epoxy equivalent epoxy resin. Preferably, the high epoxy equivalent epoxy resin may have an epoxy equivalent in the range of 900 g/eq to 2500 g/eq. In some embodiments, the high epoxy equivalent epoxy resin may have an epoxy equivalent in the range of 850 g/eq to 1200 g/eq. In some embodiments, the high epoxy equivalent epoxy resin may have an epoxy equivalent in the range of 1400 g/eq to 2500 g/eq, for example, in the range of 1600 to 1800 g/eq, or in the range of 1700 to 2200 g/eq.

Suitable epoxy resin comprises, for example diglycidyl ether of polyhydric phenol, such as diglycidyl ether of resorcinol, diglycidyl ether of catechol, diglycidyl ether of hydroquinone, diglycidyl ether of bisphenol A, diglycidyl ether of bisphenol F, diglycidyl ether of bisphenol S, diglycidyl ether of tetramethyl bisphenol; diglycidyl ether of polyalcohol, such as diglycidyl ether of aliphatic diglycol and diglycidyl ether of polyether glycol, for example diglycidyl ether of C₂₋₂₄ alkylene glycol, diglycidyl ether of poly(ethylene oxide) glycol or diglycidyl ether of poly(propylene oxide) glycol; or polyglycidyl ether of novolack resin, such as polyglycidyl ether of phenol-formaldehyde resin, polyglycidyl ether of alkyl substituted phenol-formaldehyde resin, polyglycidyl ether of phenol-hydroxyl benzaldehyde resin, or polyglycidyl ether of cresol-hydroxyl benzaldehyde resin; or the combination thereof.

According to some embodiments of the present disclosure, the epoxy resin is diglycidyl ether of polyhydric phenol, especially preferably having the structure of formula (I):

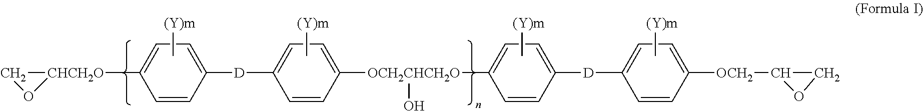

wherein
D each represents —S—, —S—S—, —SO—, —SO₂—, —CO₂—, —CO—, —O— or C₁ to C₁₀ alkylene, preferably C₁ to C₅ alkylene, more preferably C₁ to C₃ alkylene, such as —CH₂— or —C(CH₃)₂—,
Y each independently represents halogen, such as F, Cl, Br, or I, or optionally substituted monovalent C₁ to C₁₀ hydrocarbon group, such as optionally substituted methyl, ethyl, vinyl, propyl, allyl or butyl;
m each independently represents 0, 1, 2, 3 or 4, and
n represents an integer from 0 to 4, such as 0, 1, 2, 3 or 4.

More preferably, the epoxy resin is bisphenol A epoxy resin, bisphenol S epoxy resin or bisphenol F epoxy resin having the structure of formula (I) in which D represents —C(CH₃)₂—, —SO₂— or —CH₂— respectively, m represents 0, and n represents an integer from 0 to 4.

Most preferably, the epoxy resin is bisphenol A epoxy resin having the structure of formula (I) in which D represents —C(CH₃)₂—, m represents 0, and n represents an integer from 0 to 4.

The epoxy resin as disclosed herein may be prepared by the epichlorohydrin technology which is well-known by those skilled in the art, for example. Alternatively, as an example of epoxy resin, any suitable commercial product may be used, for example E55, E51, E44, or E20 available from Kaiping Resin Company, Shanghai, China; or those in the form of an aqueous epoxy resin emulsion, such as Allnex 387 from Allnex, 3907 from Huntsman, 900 and 1600 from Nanya, or EPIKOTE™ Resin 6520 from Hexion. Preferably, the aqueous epoxy resin emulsion has a solid content of 40-60% by weight.

In another preferred embodiment according to the present application, the resin component comprises a polyester resin. The term “polyester resin” is used herein to refer to a liquid polyester resin made by condensation polymerization of a polyol and a polyacid or anhydride together. Representative polyols include glycerol, pentaerythritol, sorbitol, trimethylolpropane, ethylene glycol, diethylene glycol, propylene glycol, dipropylene glycol, and other polyols known to those of ordinary skill in the art to be used in the preparation of polyester resins. Representative polyacids or anhydrides include dibasic acids or anhydrides such as phthalic acid and its anhydride, isophthalic acid, terephthalic acid, maleic acid, fumaric acid, adipic acid, sebacic acid, and the like; ternary acids such as trimellitic acid; and other polyacids or anhydrides known to those of ordinary skill in the art for use in the preparation of polyester resins.

As noted above, polyester resins can be prepared by suitable preparation methods known to those of ordinary skill in the art, or can be obtained from any suitable commercially available product. As commercial examples of polyester resins, polyester resins such as commercially available grades SH970, SH973, SH974, SN800 and SN908 from DSM in the Netherlands, or grades ES-300, ES-410, ES-450, ES-901, ES-910, ES-955, ES-960 and ES-980 from SK Chemical, or grades L205, L210, L411, LH820, LH833, LH818 and LH910 purchased from Degussa may be used.

In another embodiment according to the present application, the resin component comprises an acrylics resin. The acrylics resin suitable for use in the present application may be a water-dispersible acrylics resin, such as a polyacrylics latex, which may be made using techniques known to those of ordinary skill in the art. For example, the acrylics resin may be a copolymer of various ethylenically unsaturated compounds. Examples of suitable ethylenically unsaturated monomers include vinyl and vinylidene monomers such as styrene, alpha-methylstyrene, o- and p-chlorostyrene, o-, m- and p-methylstyrene, p-tert-butylstyrene, acrylic acid, (meth)acrylonitrile, alkyl having 1 to 8 carbon atoms esters of acrylic acid and methacrylic acid such as ethyl acrylate, methyl acrylate, n- or isopropyl acrylate n-butyl acrylate, 2-ethylhexyl acrylate, 2-ethylhexyl methacrylate, isooctyl acrylate, methyl methacrylate, ethyl methacrylate, butyl methacrylate and isooctyl methacrylate; diesters of fumaric, itaconic or maleic acid with an alcohol component having 4 to 8 carbon atoms; (meth)acrylamide; vinyl esters of alkyl monocarboxylic acids having 2 to 5 carbon atoms such as vinyl acetate or vinyl propionate and hydroxyalkyl esters of acrylic or methacrylic acid where the hydroxyalkyl residue has 2 to 4 carbon atoms, such as 2-hydroxyethyl acrylate or methacrylate, 2-hydroxypropyl acrylate or methacrylate, 4-hydroxybutyl acrylate or methacrylate, trimethylolpropane monoacrylate or methacrylate or pentaerythritol monoacrylate or methacrylate. Mixtures of these monomers are also suitable.

As an example of an acrylic resin, any conventional acrylics resin can be used, such as acrylate resin 476706 commercially available from SWIMC.

The above mentioned resin component is used for providing a film-forming composition for the chromium-free anticorrosive coating composition. In one aspect, the resin component functions as a binder which provides adhesion of coating to a substrate, and holds together other components, such as fillers, of the coating composition to impart basic cohesive strength to the paint film forming from the coating composition of the present disclosure. In the other aspect, the resin component has good reactivity with a curing agent if any, thereby providing a coating having higher mechanical strength.

Preferably, the chromium-free anticorrosive coating composition comprises about 30% to about 70% by weight of the film-forming composition relative to the total weight of Component A. In some embodiments of the present application, the chromium-free anticorrosive coating composition comprises at least about 32% by weight, or at least about 34% by weight, or at least about 40% by weight, or at least about 45% by weight of the film-forming composition relative to the total weight of the Component A. In the above embodiment of the present application, the chromium-free anticorrosive coating composition comprises less than about 65% by weight, or less than about 60% by weight, or less than about 55% by weight of the film-forming resin composition relative to the total weight of the Component A.

If required, the chromium-free anticorrosive coating composition further comprises a curing agent for the resin component, the type of which depends on the nature of the resin component.

The epoxy resin-containing coating composition preferably comprises an aliphatic or aromatic amine curing agent, a polyamide curing agent, or a mercaptan-based curing agent. Suitable amine curing agents are aliphatic amines and their adducts (e.g. ANCAMINE 2021), phenalkamines, cycloalicyclic amines (e.g. ANCAMINE 2196), amidoamines (e.g. ANCAMIDE 2426), polyamides and their adducts, and their mixtures.

The coating composition containing amino and/or hydroxyl functional resin preferably adopts isocyanate and isocyanurate as curing agents. Suitable isocyanate curing agents are aliphatic, cycloaliphatic and aromatic polyisocyanates, such as trimethylene diisocyanate, 1,2-propylene diisocyanate, tetramethylene diisocyanate, 2,3-butylene diisocyanate, hexamethylene diisocyanate, octamethylene diisocyanate, 2,4-trimethylhexamethylene diisocyanate, 2,4,4-trimethylhexamethylene diisocyanate, dodecamethylene diisocyanate, 1,3-cyclopentylidene diisocyanate, 1,2-cyclohexylidene diisocyanate, 1,4-cyclohexylidene diisocyanate, 4-methyl-1,3-cyclohexylidene diisocyanate, meta- and p-phenylene diisocyanate, 1,3- and 1,4- bis(isocyanate methyl)benzene, 1,5-dimethyl-2,4-bis(isocyanate methyl)benzene, 1,3,5-triisocyanatebenzene, 2,4-toluene diisocyanate, 2,6-toluene diisocyanate, 2,4,6-toluene triisocyanate, α,α,α,α′-tetramethyl o-, m -and p-xylylene diisocyanate, 4,4′-diphenylene diisocyanate methane, 4,4′-diphenylene diisocyanate, 3,3′-dichloro-4,4′-diphenylene diisocyanate, naphthalene-1,5-diisocyanate, isophorone diisocyanate, trans-vinylidene diisocyanate, and mixtures of the above-mentioned polyisocyanates. Adducts of the aforementioned polyisocyanates are also suitable, such as biuret, isocyanurate, allophonate, uretdione and mixtures thereof. Depending on the application, the above-mentioned isocyanates and their adducts may exist in the form of blocked or latent isocyanates.

In the two-component chromium-free anticorrosive coating composition according to the present application, the amount of curing agent used as Component B can be adjusted empirically by those skilled in the part based on the amount of component A, especially the amount of film-forming composition in component A. In some embodiments of the present application, the weight ratio of Component A and Component B as the curing agent may be 100:15, 100:23, 100:30 or other commonly used ratios of Component A and Component B in the art.

In embodiments according to the present application, the carrier is optional in the formulation of the chromium-free anticorrosive coating composition. In some embodiments according to the present application, the chromium-free anticorrosive coating composition does not contain a carrier and is present in the form of a powder coating composition. In some embodiments according to the present application, the chromium-free anticorrosive coating composition may include a carrier and is present in the form of a solvent-borne coating composition or an aqueous coating composition.

If present, the carrier comprises water, a water-miscible organic solvent, a water-immiscible organic solvent, or a combination thereof, thereby reducing the viscosity of the coating composition for application. The addition of organic solvents can increase the volatilization rate of the anticorrosive coating composition and accelerate the formation of the paint film. In some embodiments of the present application, the organic solvent includes ketones (such as acetone, methyl isopropyl ketone, methyl isobutyl ketone, and the like), alcohols (propanol, benzyl alcohol, and the like), esters (ethyl acetate, butyl acetate, and the like), aromatic hydrocarbons (toluene, xylene, and the like), aliphatic hydrocarbons (cyclopentane, cyclohexane, and the like) or any combination thereof.

In a preferred embodiment according to the present application, if present, the carrier may, for example, account for at least about 5% by weight, at least about 6% by weight, at least about 7% by weight, at least about 8% by weight, at least about 9% by weight, or at least about 10% by weight of the total weight of Component A. In a preferred embodiment according to the present application, if present, the carrier may, for example, account for at most about 15% by weight, at most about 14% by weight, at most about 13% by weight, or at most about 12% by weight of the total weight of Component A. Generally, the desired amount of the carrier is usually selected empirically based on the film-forming properties of the paint film.

In embodiments of the present application, the chromium-free anticorrosive coating composition may optionally further include commonly used additional additives. Suitable additional additives may include fillers, wetting and dispersing agents, defoamers, leveling agents, additional corrosion inhibitors, adhesion promoters, film forming aids, rheology modifiers, or any combination thereof.

The content of each of the above-mentioned optional ingredients is sufficient to achieve its intended purpose, but preferably, such content does not adversely affect the coating composition or the coating obtained therefrom. According to certain embodiments of the present application, the total amount of additional additives is in the range of about 0% to about 65% by weight, preferably in the range of about 0.1% to about 60% by weight relative to the total weight of Component A.

In a specific embodiment according to the present application, Component A of the chromium-free anticorrosive coating composition comprises, relative to the total weight of component A,
30-70% by weight of the film-forming composition;
3-15% by weight of the corrosion inhibiting composition;
0-15% by weight of the carrier; and
0-65% by weight of the additional additives, preferably 0.1-60% by weight of the additional additives.

In a more specific embodiment according to the present application, Component A of the chromium-free anticorrosive coating composition comprises, relative to the total weight of component A,
30-70% by weight of the film-forming composition;
0.5-6% by weight of the lithium-containing metal compound;
1.0-7.0% by weight of the aluminum-containing phosphate;
0-2.5% by weight of the cation-exchange silica gel, preferably 1.0-2.5% by weight of the cation-exchange silica gel;
0-1.5% by weight of the organic corrosion inhibitor;
0-15% by weight of the carrier; and
0-65% by weight of the additional additives, preferably 0.1-60% by weight of the additional additives.

The anticorrosive coating composition of the present application can be prepared by any suitable mixing method known to those of ordinary skill in the art. For example, the coating composition can be made by adding the film-forming composition, the lithium-containing metal compound, the aluminum-containing phosphate, the cation-exchange silica gel, the organic corrosion inhibitor (if any), the carrier (if any) and the additional additives (if any) to a container, and then stirring the resulting mixture uniformly, thereby forming the Component A. According to requirements, the curing agent as component B may exist as a single component or may be mixed with the above-mentioned components in the form of a mixture.

The chromium-free anticorrosive coating composition thus formed can be used as a primer in combination with a conventional topcoat, or can be used alone as a direct-to-metal coating composition to provide metal substrates with required anticorrosive properties. In some preferred embodiments according to the present application, the chromium-free anticorrosive coating composition is a primer. In the embodiments according to the present application, the chromium-free anticorrosive coating composition is an aqueous coating composition. Preferably, this aqueous coating composition is not only suitable for wet on wet system, but also for wet on dry system, and a two-component polyurethane may be used as a topcoat suitable for use with the primer.

As described above, the inventors of the present application surprisingly discovered that the anticorrosive coating composition as prepared can achieve excellent resistances to salt spray and to water soaking when used as a primer or as a direct-to-metal coating.

In an embodiment according to the present application, when the above-mentioned coating composition is used as a direct-to-metal coating and applied to a sandblasted steel plate in a dry paint film thickness of 40 to 70 microns and cured, and the resulting paint film is scratched to form cross-shaped scratches so as to obtain a test sample, the test sample after being subjected to a salt spray test according to ASTM B117 or GB/T1771 for 500 hours or longer, preferably 700 hours or longer, exhibits a stripping width on one side of 3 mm or less.

In an embodiment according to the present application, when the above-mentioned coating composition is used as a direct-to-metal coating and applied to a sandblasted steel plate in a dry paint film thickness of 40 to 70 microns and cured so as to obtain a test sample, the test sample after being immersed at an aqueous environment at room temperature for 500 hours or at an aqueous environment at a temperature of 40° C. for 12 days is substantially free of blistering, preferably completely free of blistering.

It was further surprisingly found by the inventors of the present application that using a wet-to-dry process or a wet-to-wet process, the combination of the anticorrosive coating composition prepared as above as a primer with a conventional topcoat (such as an aqueous polyurethane topcoat shows excellent resistances to salt spray and to water soaking, which is unexpected. As noted above, the wet-on-wet process refers to a coating process in which a second coat is applied before the first coat is completely dry. In the field of coatings, especially in the field of anticorrosive coatings, the wet-on-wet process is a more demanding coating process. It is well known that a topcoat usually reacts with a primer when the primer is not completely dry, resulting in a less dense crosslinking of the primer so that corrosion is easily to occur. However, it was particularly surprisingly found by the inventors of the present application that the anticorrosive coating composition according to the present application is particularly suitable as a primer for a wet-on-wet system, which not only does not cause construction problems such as sagging and wrinkling, but also achieves excellent anticorrosive properties, which were difficult to expect prior to the present application. As an exemplary illustration, the wet-on-wet process includes, for example, the following steps: applying a primer, leveling it at room temperature for 15 minutes, spraying a topcoat, leveling it for more than 20 minutes, and then curing the coating at 60° C. for at least 12 hours. As an exemplary illustration, the wet-to-dry process includes, for example, the following steps: applying a primer, leveling it at room temperature for 15 minutes, curing it at 60° C. for 12 hours or more, and then spraying a topcoat, leveling it for more than 20 minutes, and then curing it at 60° C. for 12 hours or more, such as 20 hours or more.

In an embodiment according to the present application, when using a wet-to-dry process, the above-mentioned coating composition is used as a primer and applied to a sandblasted steel plate in a dry paint film thickness of 40 to 70 microns and cured, and a polyurethane topcoat is applied to the dried primer in a dry paint film thickness of 40 to 70 microns and cured, and the resulting paint film is scratched to form cross-shaped scratches so as to obtain a test sample, the test sample after subjecting to a salt spray test according to ASTM B117 or GB/T1771 for 500 hours or longer, preferably 700 hours or longer, has a stripping width on one side of 3 mm or less, preferably of 2 mm or less.

In an embodiment according to the present application, when using a wet-to-wet process, the above-mentioned coating composition is used as a primer and applied to a sandblasted steel plate in a dry paint film thickness of 40 to 70 microns, and a polyurethane topcoat is applied to the wet primer in a dry paint film thickness of 40 to 70 microns and cured, and the resulting paint film is scratched to form cross-shaped scratches so as to obtain a test sample, the test sample after subjecting to a salt spray test according to ASTM B117 or GB/T1771 for 500 hours or longer, preferably 700 hours or longer, has a stripping width on one side of 3 mm or less, preferably of 2 mm or less.

In an embodiment according to the present application, when using a wet-to-dry process, the above-mentioned coating composition is used as a primer and applied to a sandblasted steel plate in a dry paint film thickness of 40 to 70 microns, and a polyurethane topcoat is applied to the wet primer in a dry paint film thickness of 40 to 70 microns and cured so as to obtain a test sample, the test sample after being immersed at an aqueous environment at room temperature for 500 hours and/or at an aqueous environment at a temperature of 40° C. for 12 days is substantially free of blistering, preferably completely free of blistering.

In an embodiment according to the present application, when using a wet-to-wet process, the above-mentioned coating composition is used as a primer and applied to a sandblasted steel plate in a dry paint film thickness of 40 to 70 microns, and a polyurethane topcoat is applied to the wet primer in a dry paint film thickness of 40 to 70 microns and cured so as to obtain a test sample, the test sample after being subjecting to soaking at an aqueous environment at room temperature for 500 hours and/or at an aqueous environment at a temperature of 40° C. for 12 days is substantially free of blistering, preferably completely free of blistering.

In another aspect, the present application provides an article comprising a metal substrate; and a coating formed of the chromium-free anticorrosive coating composition according to the present application which is directly applied to the metal substrate. As mentioned above, the chromium-free anticorrosive coating composition of the present application can be used as a primer or as a direct-to-metal coating. Therefore, in some embodiments of the present application, the article comprises a metal substrate; a primer layer formed of the chromium-free anticorrosive coating composition of the present application, which is directly coated on the metal substrate; and a topcoat formed from a conventional topcoat in the art (for example, a water-based polyurethane topcoat) applied over the primer. In other embodiments of the present application, the article comprises a metal substrate; and a coating formed of the chromium-free anticorrosive coating composition of the present application, which is directly coated on the metal substrate

As a metal substrate for manufacturing the article of the present application, any suitable metal substrate known in the art can be used. As an example, the metal substrate is one or more selected from steel, iron, aluminum, zinc, copper and their alloys.

According to the present application, the article can be prepared, for example, by the following steps: (1) providing a polished metal substrate; (2) using a coating and curing process to sequentially coat and form one or more chromium-free anticorrosive coating composition of the present application on the metal substrate to provide corrosion resistance for the metal substrate.

According to the present application, the metal articles thus obtained can be further treated with an additional anticorrosive topcoat, and can be used for the following end-use applications, including but not limited to refrigerated containers and unrefrigerated shipping containers (e.g., dry cargo containers) from suppliers or manufacturers including China International Marine Containers (CIMC), Graaff Transportsysteme Gmbh, Maersk Line and others that will be familiar to persons having ordinary skill in the art, chassis, trailers including semitrailers, rail cars, truck bodies, ships, bridges, building skeletons, and other prefabricated or site-fabricated metal articles needing temporary indoor or outdoor corrosion inhibition during fabrication. Additional uses include metal angles, channels, beams (e.g., I-beams), pipes, tubes, plates and other components that may be welded into these and other metal articles, and the like.

The present disclosure is more particularly described in the following examples that are intended as illustrations only, since numerous modifications and variations within the scope of the present disclosure will be apparent to those skilled in the art. Unless otherwise noted, all parts, percentages, and ratios reported in the following examples are on a weight basis, and all reagents used in the examples are commercially available and used directly without further treatment.

### Examples

### Test Methods

Salt Spray resistance

According to needs, the anticorrosive coating composition was used as a primer or as a direct-to-metal coating and applied to a sandblasted steel plate in a dry paint film thickness of 40 to 70 microns and cured to form a test sample. Where the anticorrosive coating composition was used as a primer, the test sample also had a commercially available waterborne polyurethane (WKY0305, from Valspar Corporation) topcoat applied over the primer in a dry paint film thickness of 40 to 70 microns.

Then, the obtained test sample was subjected to a salt spray test according to ASTM B117 or GB/T1771 for 500 hours or more, and the stripping width of scratches on one side was measured. When the stripping width on one side after 500 hours of salt spray test exceeded 2 mm or the stripping width on one side after 700 hours of salt spray test exceeded 3 mm, the test sample was considered unqualified and had poor wet adhesion. When the stripping width on one side after the 500-hour salt spray test was 2 mm or less or the stripping width on one side after 700 hours of salt spray test was 3 mm or less, the test sample was considered to be qualified.

### Water Resistance

According to needs, the anticorrosive coating composition was used as a primer or as a direct-to-metal coating and applied to a sandblasted steel plate in a dry paint film thickness of 40 to 70 microns and cured to form a test sample. Where the anticorrosive coating composition was used as a primer, the test sample also had a commercially available waterborne polyurethane (WKY0305, from Valspar Corporation) topcoat applied over the primer in a dry paint film thickness of 40 to 70 microns.

Then, the obtained test sample was subjected to soaking at an aqueous environment at room temperature for 500 hours or at an aqueous environment at a temperature of 40° C. for 12 days and was observed whether there are blistering on the surface of the coating. If the test sample was subjected to soaking at an aqueous environment at room temperature for 500 hours or at an aqueous environment at a temperature of 40° C. for 12 days and there was blistering on the surface of the coating, the test sample was considered to be unqualified. If the test sample was subjected to soaking at an aqueous environment at room temperature for 500 hours or at an aqueous environment at a temperature of 40° C. for 12 days and there was no blistering on the surface of the coating, the test sample was considered to be qualified.

### Epoxy Resin-Based Anticorrosive Coating Composition

As shown in Table 1, the components of component A were mixed to obtain a mixture, which was then mixed with the curing agent as Component B to form the epoxy resin-based anticorrosive coating composition according to Examples 1 to 5 (Ex. 1-4) of the present application and Comparative Examples A and B (CEx. A and B), wherein Comparative Example A had a corrosion inhibiting composition consisting of a conventional chromium-free rust inhibitor aluminum tripolyphosphate and calcium ion-exchange silica gel, and Comparative Example B had a corrosion inhibiting composition consisting of a conventional chromium-free rust inhibitor aluminum tripolyphosphate, calcium ion-exchange silica gel and an organic rust inhibitor, but without a lithium-containing metal compound.

TABLE 1
Composition and amount of epoxy resin-based anticorrosive coating composition

| Raw materials/g | | CEx. 1 | CEx. 2 | Ex. 1 | Ex. 2 | Ex. 3 | Ex. 4 | Ex. 5* | Ex. 6** |
|---|---|---|---|---|---|---|---|---|---|
| Component A | | | | | | | | | |
| Epoxy resin | | 44 | 44 | 44 | 44 | 44 | 44 | 44 | 44 |
| Corrosion | Lithium iron phosphate | — | — | 6.0 | 4.4 | 3.25 | 1.0 | 4.47 | 4.2 |
| Inhibiting | aluminum tripolyphosphate | 6.5 | 5.5 | 2.0 | 2.0 | 3.0 | 5.55 | 2.0 | 1.8 |
| Composition | calcium ion-exchange silica | 1.5 | 1.5 | — | 1.6 | 1.4 | 1.2 | 1.1 | 1.3 |
| | gel | | | | | | | | |
| | Organic rust inhibitor | — | 1.0 | — | — | 0.35 | 0.25 | 0.43 | 0.7 |

| | | | | | | | | |
|---|---|---|---|---|---|---|---|---|
| Carrier | 12 | 12 | 12 | 12 | 12 | 12 | 12 | 13 |
| Additive | 6 | 6 | 6 | 6 | 6 | 6 | 6 | 7 |
| Filler | 30 | 30 | 30 | 30 | 30 | 30 | 30 | 28 |
| Total | 100 | 100 | 100 | 100 | 100 | 100 | 100 | 100 |
| Component B | | | | | | | | |
| Epoxy resin curing agent-1 | 15 | 15 | 15 | 15 | 15 | 15 | 15 | 15 |
| Coating Performances | | | | | | | | |
| Salt spray resistance@522 hours/mm | 3.01 | 2.60 | 1.89 | 1.69 | 2.0 | 1.75 | 1.85 | 1.57 |
| Salt spray resistance@825 hours/mm | 5.26 | 3.82 | 2.71 | 2.63 | 2.6 | 2.68 | 2.34 | 2.15 |
| Water resistance@40° C., 10 days | No | Blistering | No | No | No | No | No | No |
| | blistering | | blistering | blistering | blistering | blistering | blistering | blistering |

*In example 5, the test sample was subjected to the salt spray resistance test for 504 hours and 785 hours, and was subjected to the water resistance test by soaking in an aqueous environment at 40° C. for 12 days; and
**In example 6, the test sample was subjected to the salt resistance test for 525 hours and 825 hours, and was subjected to the water resistance test by soaking in an aqueous environment at 40° C. for 12 days.

### Anticorrosive Performance of Epoxy-Based Coating Composition

As shown in Examples 1-6, in the anticorrosive coating composition according to the present application, a combination of lithium iron phosphate, aluminum tripolyphosphate, and optionally calcium ion-exchange silica gel was used as a corrosion inhibiting composition. As a control, a comparable amount of aluminum tripolyphosphate (counterpart A) and a comparable amount of a combination of aluminum tripolyphosphate and an organic rust inhibitor (counterpart B) were used instead of the combination of lithium iron phosphate and aluminum tripolyphosphate. Then, an aqueous polyurethane topcoat was applied to the incompletely dried primer formed from the coating compositions of Examples 1-6 and Comparative Examples A and B to form a topcoat. The resulting composite coatings were subjected to a salt spray test according to ASTM B117 for at least 500 hours and 700 hours, respectively, and to a water resistance test at 40° C. for at least 10 days.

As can be seen from the results of Examples 1-6 in Table 1, a combination of lithium iron phosphate, aluminum tripolyphosphate, and optionally calcium ion-exchange silica gel used as a corrosion inhibiting composition has successfully formulated a anticorrosive coating composition with excellent salt spray resistance and water resistance both. In contrast, the combination of lithium iron phosphate and aluminum tripolyphosphate was replaced by a comparable amount of aluminum tripolyphosphate (Comparative Example A), resulting in a significant decrease in salt spray resistance of the resulting composite coating, which could not meet the corrosion resistance requirements of the anticorrosive coating. Similarly, the combination of lithium iron phosphate and aluminum tripolyphosphate was replaced by a comparable amount of a combination of aluminum tripolyphosphate and an organic rust inhibitor (counterpart B), causing the results that the resulting composite coating could not meet the application requirements in term of salt spray resistance and water resistance.

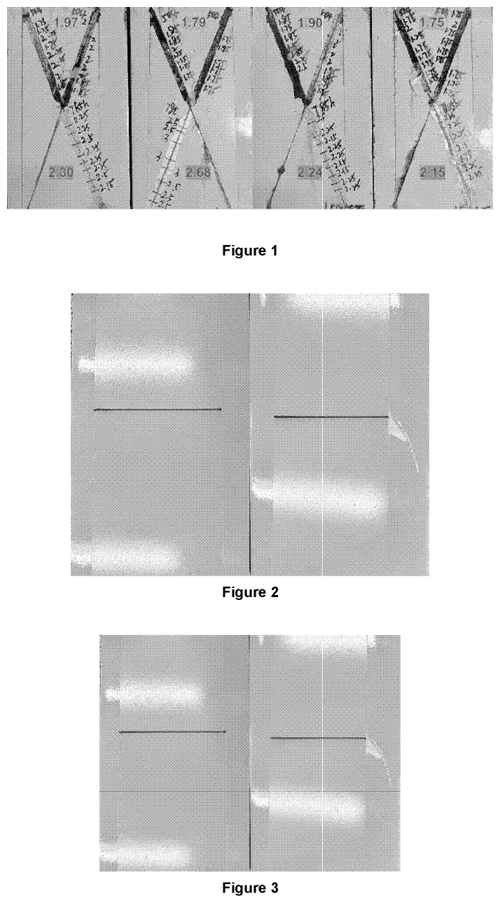

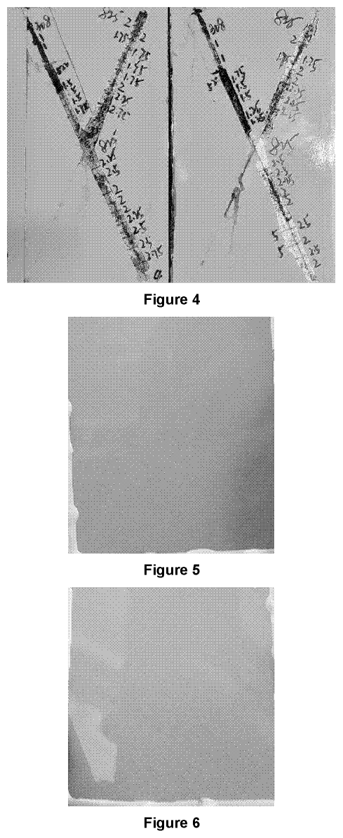

In order to show more visually the salt spray resistance and water resistance of the anticorrosive coating compositions according to the present application, photographs of the coatings formed from the anticorrosive coating compositions of Examples 5 and 6 after being subjected to the salt spray test were shown in FIGS. 1 (Example 5) and 4 (Example 6), and photographs after being subjected to water resistance test were shown in FIGS. 2-3 (Example 5) and FIGS. 5-6 (Example 6). As shown in FIGS. 1-6, the coating formed from the chromium-free anticorrosive coating composition comprising the combination of lithium iron phosphate, aluminum tripolyphosphate, and calcium ion-exchange silica gel according to the present application exhibited excellent salt spray resistance which was demonstrated by the fact that the coating had a limited stripping width on one side after being subjected to a salt spray test according to ASTM B117, none of which exceeded 3 mm, while exhibiting an excellent water resistance which was demonstrated by the fact that the coating did not blister and had a smooth surface after being subjected to soaking in water at 40° C. for 12 days or longer and soaking in water at room temperature for 500 hours.

While the present disclosure has been described with respect to a number of embodiments and examples, those skilled in the art, having benefit of this invention, will appreciate that other embodiments can be devised which do not depart from the scope of the present disclosure as disclosed herein.

What is claimed is:

23. A chromium-free anticorrosive coating composition, comprising:
Component A, comprising a film-forming composition;
a corrosion inhibiting composition;
optional carriers; and
additional additives, wherein the corrosion inhibiting composition comprises
at least one lithium-containing metal compound having a spatially stable crystalline structure;
at least one aluminum-containing phosphate; and
optionally Component B, comprising a curing agent.

24. The chromium-free anticorrosive coating composition according to claim 23, wherein the at least one lithium-containing metal compound has a layered structure, a spinel structure, an olivine structure or a tunnel structure.

25. The chromium-free anticorrosive coating composition according to claim 23, wherein the at least one lithium-containing metal compound comprises a lithium-containing composite metal compound further comprising at least one transition metal element.

26. The chromium-free anticorrosive coating composition according to claim 25, wherein the at least one transition metal element comprises one or more of nickel, cobalt, manganese, iron and titanium.

27. The chromium-free anticorrosive coating composition according to claim 23, wherein the at least one lithium-containing metal compound comprises one or more of lithium manganese oxide, lithium nickel cobalt manganese oxide, lithium cobalt oxide, lithium phosphate and lithium iron phosphate, preferably lithium iron phosphate.

28. The chromium-free anticorrosive coating composition of claim 23, wherein relative to the total weight of Component A, the at least one lithium-containing metal compound is present in an amount of 0.5% by weight or more but not more than 6% by weight.

29. The chromium-free anticorrosive coating composition of claim 23, wherein the at least one aluminum-containing phosphate comprises one or more of aluminum-containing orthophosphate, aluminum-containing polyphosphate, aluminum-containing metaphosphate, aluminum-containing phosphite, and aluminum-containing hypophosphite.

30. The chromium-free anticorrosive coating composition of claim 23, wherein relative to the total weight of the Component A, the at least one aluminum-containing phosphate is present in an amount of 1.0% by weight or more but not more than 7.0% by weight.

31. The chromium-free anticorrosive coating composition of claim 23, wherein the corrosion inhibiting composition further comprises at least one cation exchange silica.

32. The chromium-free anticorrosive coating composition according to claim 31, wherein the at least one cation exchange silica gel is porous.

33. The chromium-free anticorrosive coating composition according to claim 31, wherein the at least one cation exchange silica gel comprises one or more of magnesium ion exchange silica gel, barium ion exchange silica gel, aluminum ion exchange silica gel and calcium ion exchange silica gel, preferably calcium ion exchange silica gel.

34. The chromium-free anticorrosive coating composition according to claim 31, wherein relative to the total weight of the component A, the at least one cation exchange silica gel is present in an amount of 1.0% by weight or more but not more than 2.5% by weight.

35. The chromium-free anticorrosive coating composition of claim 23, wherein the corrosion inhibiting composition further comprises at least one organic corrosion inhibitor, and the organic corrosion inhibitor is present in an amount of 0 to 1.5% by weight relative to the total weight of the component A.

36. The chromium-free anticorrosive coating composition of claim 23, wherein the film-forming composition comprises at least one of inorganic silicates, epoxy resin, chlorinated resin, polyaspartate, alkyd resin, phenolic resin, polyurethane, polysiloxane, polyester resin, and acrylic resin.

37. The chromium-free anticorrosive coating composition of claim 23, wherein the carrier comprises water, a water-miscible organic solvent, a water-immiscible organic solvent, or a combination thereof.

38. The chromium-free anticorrosive coating of claim 23, wherein the chromium-free anticorrosive coating composition is an aqueous coating composition.

39. The chromium-free anticorrosive coating composition of claim 23,
wherein, relative to the total weight of Component A, the Component A comprises:
30-70% by weight of the film-forming composition;
3-15% by weight of the corrosion inhibiting composition;
0-15% by weight of the carrier; and
0-65% by weight of the additional additives.

40. The chromium-free anticorrosive coating composition of claim 23, wherein the chromium-free anticorrosive coating composition is a primer or a direct-to-metal coating, preferably a primer suitable for a wet-on-wet system or a wet-on-dry system.

41. An article comprising
a metal substrate; and
a coating formed from the chromium-free anticorrosive coating composition directly applied to the metal substrate, wherein the metal substrate is selected from one or more of steel, iron, aluminum, zinc, copper, and alloys thereof.
